(19) United States
(12) Patent Application Publication
(10) Pub. No.: US 2026/0045989 A1
(43) Pub. Date: Feb. 12, 2026

(54) METHOD AND APPARATUS FOR WI-FI SENSING THROUGH MU-MIMO BEAMFORMING FEEDBACK LEARNING

(71) Applicant: Northeastern University, Boston, MA (US)

(72) Inventors: Francesco Restuccia, Boston, MA (US); Khandaker Foysal Haque, Westbrook, ME (US); Milin Zhang, Portland, ME (US)

(21) Appl. No.: 19/101,116

(22) PCT Filed: Aug. 31, 2023
(86) PCT No.: PCT/US2023/031651

§ 371 Date: Feb. 4, 2025

Related U.S. Application Data
(60) Provisional application No. 63/374,339, filed on Sep. 1, 2022.

(51) Int. Cl. H04B 7/06; H04B 7/0452; H04B 17/309; H04W 84/12

(52) U.S. Cl. CPC H04B 7/0617; H04B 7/0452; H04B 17/309; H04W 84/12

(57) ABSTRACT

A method of mapping a signal propagation environment comprises receiving beamforming feedback information (BFI) produced by a wireless beamforming system, extracting one or more beamforming parameters from the BFI, aggregating the one or more beamforming parameters, and storing the aggregated beamforming parameters in a labeled dataset. The method may further comprise evaluating the aggregated beamforming parameters in the labeled dataset to generate a map of the signal propagation environment. The one or more beamforming parameters may comprise one or more angles associated with a feedback matrix. The method may further comprise training, using the labeled dataset as one or more training vectors, a model of the signal propagation environment. The method may further comprise extracting the one or more beamforming parameters from one or more BFI packets.

### RELATED APPLICATION

This application claims the benefit of U.S. Provisional Application No. 63/374,339, filed on Sep. 1, 2022. The entire teachings of the above application(s) are incorporated herein by reference.

### GOVERNMENT SUPPORT

This invention was made with government support under 2134973 from National Science Foundation. The government has certain rights in the invention.

### BACKGROUND

Wireless protocols such as IEEE 802.11 (also referred to herein as Wi-Fi) may be used to provide Internet connectivity in an indoor environment. Beyond connectivity, Wi-Fi signals can be used as sounding waveforms to perform activity recognition, health monitoring, and human presence detection, among others.

The intuition behind Wi-Fi sensing is that humans act as obstacles to the propagation of radio signals in the environment. Specifically, when encountering the human body, the radio waves undergo reflections, diffractions and scattering that make the signals collected at the Wi-Fi receiver differ from the transmitted ones. Wi-Fi sensing aims at detecting the changes in the Wi-Fi signals and associating them to the way the subject stays/moves in the environment, thus realizing device-free monitoring solutions.

To date, the vast majority of Wi-Fi sensing systems leverage channel measurements obtained from pilot symbols as sensing primitive. Such measurements are usually referred to as channel state information (CSI) and describe the way the signals propagate in the environment. Despite leading to good performance, CSI-based techniques require extracting and recording the CSI estimated by the Wi-Fi devices involved in the sensing activities, and such operations are currently not supported by the IEEE 802.11 standard.

This has led to the introduction of custom-tailored firmware modifications to extract the CSI, which makes the sensing process not scalable. Such CSI extraction tools only provide support for single-user multiple-input multiple-output (MIMO) sensing as the channel is sounded on the link between the transmitter and the device implementing the extraction tool. Therefore, Wi-Fi sensing approaches relying on CSI extraction tools cannot benefit from the spatial diversity that can be gained through multi-user MIMO (MU-MIMO) transmissions. Spatial diversity may be achieved considering multiple CSI collectors, but this would increase the computation burden as synchronization among the devices would be needed.

Moreover, even if CSI extraction could be supported in the future without the need for custom-tailored firmware modifications, CSI extraction would still require additional processing to extract the data from the chip, thus increasing energy consumption. Since the CSI is computed at the physical layer (PHY), it is not readily available with off the-shelf network interface cards (NICs).

Although CSI can be extracted with SDR implementations, which only support up to 40 MHz of bandwidth, being only IEEE 802.11 a/g/p/n compliant. Moreover, SDRs are costly specialized hardware that may be unavailable in real-life situations and require expert knowledge to be used.

To overcome such limitations, researchers in recent years have developed some CSI extraction tools that run on commercial Wi-Fi NICs. Two of them, namely Linux CSI and Atheros CSI, target IEEE 802.11n compliant NICs (up to 40 MHz bandwidth). Another CSI extraction tool, Nexmon CSI, allows extracting the CFR from some IEEE 802.11ac compliant devices, supporting bandwidths up to 80 MHz. Yet another CSI extraction tool, AX CSI, is designed for IEEE 802.11ax devices and provides CFR measurements also on 160 MHz bandwidth channels.

All of these CSI extraction tools, however, require non-trivial firmware modifications of the commercial NICs. Moreover, they do not provide support for estimating the channel on MU-MIMO channels. When the CSI extractor tool is implemented on either one receiving Wi-Fi device or on another monitor device, only the MIMO links between the transmitter and the CSI collector is monitored, i.e., only SU-MIMO mode is supported.

### SUMMARY

The example embodiments described herein are directed to systems and methods that leverage beamforming feedback information (BFI), which is transmitted as part of the system's multi-user multiple-input multiple-output (MU-MIMO) protocol, to determine and extract information about the area signal propagation conditions (i.e., channel state information).

The systems constructed according to the described embodiments operate by exploiting the MU-MIMO beamforming feedback to sense the environment. The collection of the MU-MIMO beamforming feedback packets be implemented with, for example, any standard-compliant 802.11 ac/ax device, and the described embodiments do not need direct access or close proximity to the sensed subject. The described embodiments are less sensitive to the accurate placement of the STAs because the described embodiments utilize the aggregated feedback from different users placed at different locations.

In one aspect, the invention may be a method of mapping a signal propagation environment, comprising receiving beamforming feedback information (BFI) produced by a wireless beamforming system, extracting one or more beamforming parameters from the BFI, aggregating the one or more beamforming parameters, and storing the aggregated beamforming parameters in a labeled dataset. The method may further comprise evaluating the aggregated beamforming parameters in the labeled dataset to generate a map of the signal propagation environment.

The one or more beamforming parameters comprise one or more angles associated with a feedback matrix. The method may further comprise training, using the labeled dataset as one or more training vectors, a model of the signal propagation environment. The method may further comprise extracting the one or more beamforming parameters from one or more BFI packets. The one or more beamforming parameters from each BFI packet are stored with one or more of (i) an associated activity, (ii) an associated phenomenon, and (iii) a timestamp that designates when the BFI packet was collected.

The method may further comprise training a model to perform classification of an activity, wherein the model implements a deep learning procedure. The deep learning procedure may comprise a meta-learning stage and a micro-learning stage.

The method of claim 1, wherein the aggregated beamforming parameters comprise an input tensor of S×K×A×U, where S represents a number of BFI packets collected, K represents a number of OFDM sub-channels, A represents a number of BFI angles in each packet, and U represents a number of MU-MIMO users. The wireless beamforming system may be an IEEE 802.11-based system.

In another aspect, the invention may be a system for mapping a signal propagation environment, comprising a receiver configured to receive beamforming feedback information (BFI) produced by a wireless beamforming system, a processor, and a memory with computer code instructions stored thereon. The memory is operatively coupled to the processor such that, when executed by the processor, the computer code instructions may cause the system to extract one or more beamforming parameters from the BFI, aggregate the one or more beamforming parameters, and store the aggregated beamforming parameters in a labeled dataset. The computer code instructions may further cause the system to evaluate the aggregated beamforming parameters in the labeled dataset to generate a map of the signal propagation environment.

The one or more beamforming parameters may comprise one or more angles associated with a feedback matrix. The computer code instructions further cause the system to train, using the labeled dataset as one or more training vectors, a model of the signal propagation environment. The computer code instructions may further cause the system to extract the beamforming parameters from one or more BFI packets. The one or more beamforming parameters from each BFI packet may be stored with one or more of (i) an associated activity, (ii) an associated phenomenon, and (iii) a timestamp that designates when the BFI packet was collected. The computer code instructions further cause the system to train a model to perform classification of an activity, and the model implements a deep learning procedure. The deep learning procedure may comprise a meta-learning stage and a micro-learning stage.

The aggregated beamforming parameters may comprise an input tensor of S×K×A×U, where S represents a number of BFI packets collected, K represents a number of OFDM sub-channels, A represents a number of BFI angles in each packet, and U represents a number of MU-MIMO users. The wireless beamforming system is an IEEE 802.11-based system.

In another aspect, the invention may be a method of mapping a signal propagation environment, comprising receiving beamforming feedback information (BFI) produced by a wireless beamforming system, extracting one or more beamforming parameters from the BFI, aggregating the one or more beamforming parameters, and storing the aggregated beamforming parameters in a labeled dataset. The method may further comprise constructing a set of training vectors using the labeled dataset, and training a model of the signal propagation environment by applying the set of training vectors to the model of the signal propagation environment. The method may further comprise training a classification model configured to classify an activity, wherein the model implements a deep learning procedure.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1A illustrates a prior art system that utilizes individual CSI collectors.

FIG. 1B illustrates the evaluation and extraction of the signal propagation environment according to the invention.

FIG. 2 shows a high-level overview of an example embodiment of the invention.

FIG. 3 shows an example of how beamforming is conducted in an example 3×2 MIMO system.

FIG. 4 illustrates BFI packet processing according to the invention.

FIG. 5 shows how few-shot learning (FSL) is implemented according to the invention.

FIG. 6 illustrates an example VGG-based CNN network architecture according to the invention.

FIG. 7 shows a diagram of an example internal structure of a processing system that may be used to implement one or more of the embodiments herein.

### DETAILED DESCRIPTION

The embodiments described herein utilize beamforming feedback information produced by a wireless system with beamforming capabilities to determine and map a signal propagation environment. Although the example embodiments described herein are IEEE 802.11 (i.e., WiFi)-based systems, it should be understood that the concepts disclosed may apply to any wireless system that utilizes beamforming feedback information.

The example embodiments described herein leverage the multi-user, multiple-input multiple-output (MU-MIMO) capabilities of Wi-Fi to increase sensing performance while substantially reducing sensing overhead.

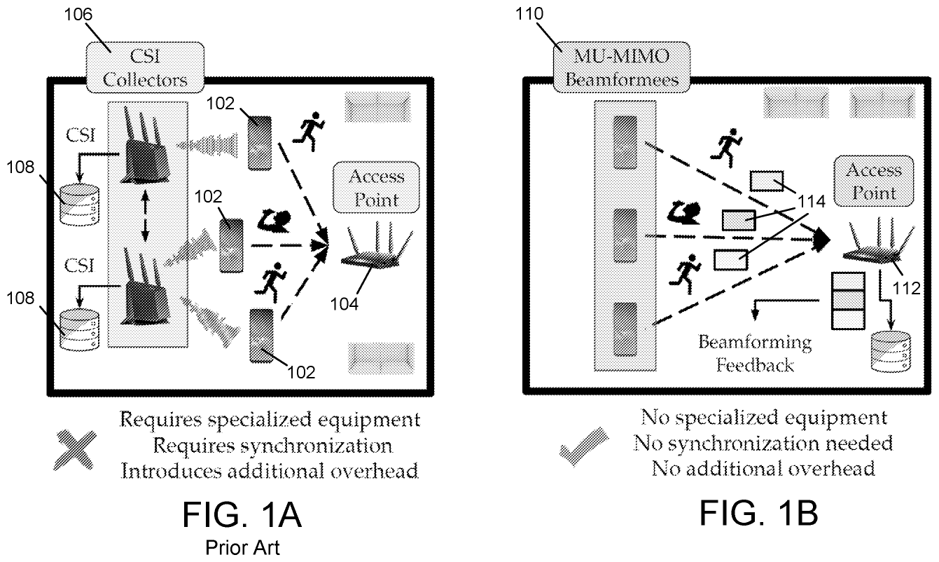

FIG. 1A illustrates a prior art system that utilizes individual channel state information (CSI) collectors, where each CSI collector is specialized to extract a specific type of CSI. The devices (stations or STAs) 102 communicate with an access point (AP) 104 to evaluate the signal propagation environment and extract CSI. The CSI gathered by STAs 102 is collected by individual CSI collectors 106. Each CSI collector 106 stores the collected CSI in its own specialized database 108. The system shown in FIG. 1A requires manual extraction of CSI from Wi-Fi chipsets to classify sensed activities, which is not supported by the Wi-Fi standard and hence requires the usage of specialized equipment.

This has led to the introduction of custom-tailored firmware modifications to extract the CSI, which makes the sensing process not scalable. Such CSI extraction tools only provide support for single-user MIMO sensing as the channel is sounded on the link between the transmitter and the device implementing the extraction tool. Therefore, Wi-Fi sensing approaches relying on CSI extraction tools cannot benefit from the spatial diversity that can be gained through MU-MIMO transmissions. Spatial diversity may be achieved by considering multiple CSI collectors, but doing so increases the computation burden as synchronization among the devices is required. Moreover, even if CSI extraction could be supported in the future without the need for custom-tailored firmware modifications, it would require additional processing to extract the data from the chip, thus increasing energy consumption.

FIG. 1B illustrates the evaluation and extraction of the signal propagation environment according to the described embodiments. MIMO STAs 110, communicating with a Wi-Fi AP 112, generate beamforming feedback information (BFI) 114. That BFI 114 is collected and evaluated to extract information about the signal propagation environment. As shown in FIG. 1B, the example embodiments leverage the beamforming feedback information (BFI), which is used by the example embodiments to beamform transmissions, to estimate the propagation environment between the access point (AP) and the connected stations (STAs).

In contrast with CSI-based sensing, the system shown in FIG. 1B does not need firmware modifications, since any off-the-shelf Wi-Fi device can capture BFI packets. The BFI packets are sent unencrypted to keep the processing delay below a few milliseconds. Further, the system shown in FIG. 1B does not require synchronization among receivers, since a single BFI report contains the information about all the MIMO channels established between the APS and the STAs.

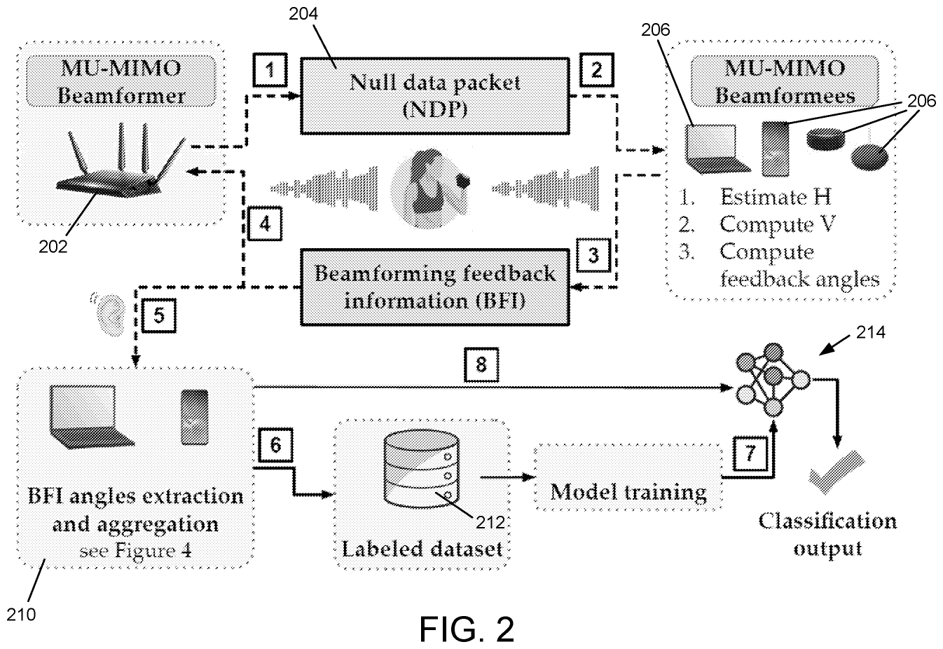

FIG. 2 shows a high-level overview of an example embodiment of the invention, which leverages the channel estimation mechanism standardized in IEEE 802.11 to evaluate the physical signal propagation environment. The channel estimation is performed on the STAs (referred to herein as beamformees) and is reported to the AP (beamformer) that uses the channel estimation information to properly beamform MU-MIMO transmissions. The channel estimation report is referred to as the BFI and is transmitted over the air in clear text.

Since the AP continuously triggers the channel estimation procedure on the connected STAs, the BFI contains very rich, reliable, and spatially diverse information. Moreover, the BFI can be collected with a single capture by the AP or any other Wi-Fi-compliant device, thus reducing the system complexity. The described embodiments are therefore a novel way to perform Wi-Fi sensing. While the prior art deals with the well-known CSI data, the described embodiments instead use the BFI as a sensing primitive.

BFI represents a completely new type of data. While CSI consists of complex I/Q-values, BFI is expressed in terms of compressed rotational matrices. The described embodiments therefore extract the BFI data embedded within Wi-Fi frames transmitted from the beamformees to the beamformer as part of the existing channel sounding procedure. The described embodiments implement a data processing pipeline for the new data type that performs activity classification based on BFI data and provides environment adaptation features.

As used herein, the superscripts T and † to denote the transpose and the complex conjugate transpose (i.e., the Hermitian). We define with ∠C the matrix containing the phases of the complex-valued matrix C. Moreover, diag (c₁, . . . , cⱼ) indicates the diagonal matrix with elements (c₁, . . . , cⱼ) on the main diagonal. The (c₁, c₂) entry of matrix C is defined by [C]_{c}_{₁}_{,c}_{₂}, while [symbol] _{c} refers to an identity matrix of size c×c and [symbol] _{c×d} is a c×d generalized identity matrix.

The sensing system of the described embodiments entails eight steps, as depicted in FIG. 2. The process stems from the way beamforming is implemented in IEEE 802.11 networks, which is depicted in steps 1, 2, 3, and 4 in FIG. 2. Specifically, the beamformer (AP) uses a matrix W of pre-coding weights—called steering matrix—to linearly combine the signals to be simultaneously transmitted to the different beamformees (STAs). The steering matrix is derived from the CFR matrices H estimated by each of the beamformee and that describe how the environment modifies the irradiated signals in their path to the receivers.

The estimation process is called channel sounding and is initiated (step 1, indicated by the number ‘1’ within a square box) by the AP 202, which periodically broadcasts a null data packet (NDP) 204. The NDP contains sequences of bits referred to as long training fields (LTFs), the decoded versions of which are known by the beamformees. Since its purpose is to sound the channel, the AP 202 does not beamform the NDP 204. This is particularly advantageous for sensing purposes because the resulting CFR estimation will not be affected by inter-stream or inter-user interference.

The LTFs are transmitted over the different beamformer antennas in subsequent time slots, thus allowing each beamformee to estimate the CFR of the links between its receiving antennas and the beamformer transmitting antennas. The LTFs are modulated—as the data fields-through orthogonal frequency division multiplexing (OFDM) by dividing the signal bandwidth into K partially overlapping and orthogonal sub-channels spaced apart by 1/T. The input bits are grouped into OFDM symbols, a=[a_{-K/2}, . . . , a_{K/2-1}], where aₖ is named OFDM sample. These K OFDM samples are digitally modulated and transmitted through the K OFDM sub-channels in a parallel fashion, thus occupying the channel for T seconds. The transmitted LTF signal is

$${s}_{tx} ( t ) = {e}^{j 2 π {f}_{c} t} {\sum }_{k = - K / 2}^{K / 2 - 1} {a}_{k} {e}^{j 2 π kt / T} , \qquad ( 1 )$$

where f_{c} is the carrier frequency. The NDP 204 is received and decoded (step 2) by each STA 206 to estimate the CFR H. The different LTFs are used to estimate the channel over each pair of transmitting (TX) and receiving (RX) antennas, for every OFDM sub-channel. This generates a K×M×N matrix H for each beamformee, where M and N are the numbers of TX and RX antennas, respectively.

Next, the CFR is compressed—to reduce the channel overhead- and conveyed (step 3) back to the beamformer 202. Using Hₖ to identify the M×N sub-matrix of H containing the CFR samples related to sub-channel k, the compressed beamforming feedback is obtained as follows. First, Hₖ is decomposed through singular value decomposition (SVD) as

$${H}_{k}^{T} = {U}_{k} {S}_{k} {Z}_{k}^{†} , \qquad ( 2 )$$

where Uₖ and Zₖ are, respectively, N×N and M×M unitary matrices, while the singular values are collected in the N×M diagonal matrix Sk. Using this decomposition, the complex-valued beamforming matrix Vₖ is defined by collecting the first N_{SS}≤N columns of Zₖ. Such a matrix is used by the beamformer to compute the pre-coding weights for the N_{SS} spatial streams directed to the beamformee. Hence, Vₖ is converted into polar coordinates as detailed in Algorithm 1:

Algorithm 1: Vₖ matrix decomposition

```
Require: Vₖ;
\tilde{D}ₖ = diag(e^{j∠[V}^{ₖ}^{]}^{_{M, 1}}, . . . ,e^{j∠[V}^{ₖ}^{]}^{_{M, N}}_{_{SS}});
${Ω}_{k} = {V}_{k} {\tilde{D}}_{k}^{†} ;$
for i ← 1 to min(N_{SS}, M − 1) do [symbol]
  = ∠ [Ωk [symbol]  with [symbol]  = i, . . . , M − 1;
  compute D_{k, i} through Eq. [symbol] ;
  ${Ω}_{k} ← {D}_{k , i}^{†} {Ω}_{k} ;$
  for [symbol]  ← i + 1 to M do
    ${ψ}_{k , ℓ , i} = arccos ( \frac{{[ {Ω}_{k} ]}_{i , i}}{\sqrt{{[ {Ω}_{k} ]}_{i , i}^{2} + [ {Ω}_{k}}} ) ;$
    compute [symbol]  through Eq. [symbol]    ;
    Ωₖ ← [symbol]    Ωₖ;
```

to avoid transmitting the complete matrix. The output is matrices D_{k,i} and G_{k,l,i}, defined as

$${D}_{k , i} = [ \begin{matrix} & 0 & \\ & ⋯ & 0 \\ 0 & {e}^{j {ϕ}_{k , ℓ , i}} & 0 & ⋯ & ⋮ \\ \\ & 0 & ⋱ & 0 & \\ \\ ⋮ & ⋮ & 0 & {e}^{j {ϕ}_{k , M - 1 , i}} & 0 \\ 0 & ⋯ & \\ & 0 & 1\end{matrix} ] , \qquad ( 3 )$$

$${G}_{k , ℓ , i} = [ \begin{matrix} & 0 & \\ & ⋯ & 0 \\ 0 & cos {ψ}_{k , ℓ , i} & 0 & sin {ψ}_{k , ℓ , i} & \\ \\ \\ & 0 & & 0 & ⋮ \\ ⋮ & - sin {ψ}_{k , ℓ , i} & 0 & cos {ψ}_{k , ℓ , i} & 0 \\ 0 & ⋯ & \\ & 0 & \end{matrix} ] , \qquad ( 4 )$$

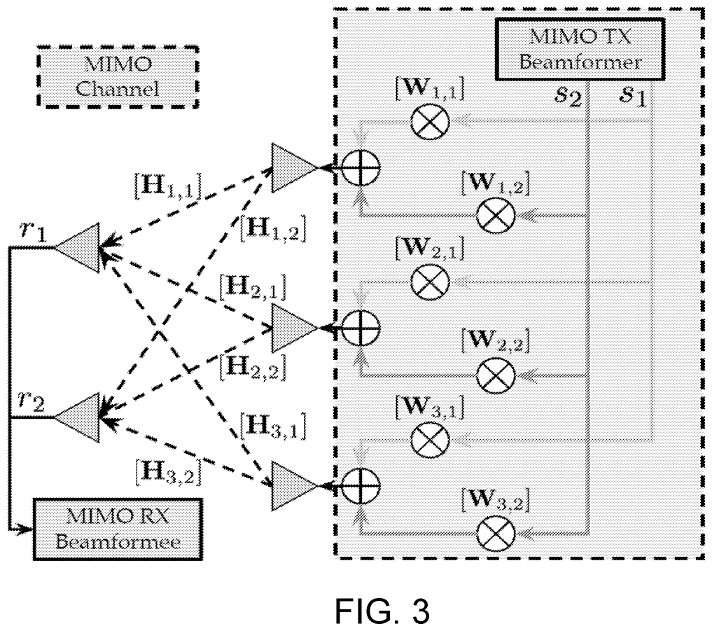

that allow rewriting Vₖ as Vₖ=\tilde{V}ₖ\tilde{D}ₖ, with

$${\tilde{V}}_{k} = {\prod }_{i = 1}^{min ( {N}_{SS} , M - 1 )} ( {D}_{k , l} {\prod }_{l = i + 1}^{M} {G}_{k , ℓ , i}^{T} ) , \qquad ( 5 )$$

where the products represent matrix multiplications. The last row in the \tilde{V}ₖ matrix, i.e., the feedback for the M^{th} transmitting antenna, consists of non-negative real numbers by construction. Using this transformation, the beamformee is only required to transmit the φ and ψ angles to the beamformer as they allow reconstructing \tilde{V}ₖ precisely. Moreover, it can be shown that the beamforming performance is equivalent at the beamformee when using Vₖ or \tilde{V}ₖ to construct the steering matrix W. In turn, the feedback for \tilde{D}ₖ is not fed back to the beamformer. The angles are quantized using b_{φ}∈{7,9} bits for φ, and b_{ψ}=b_{φ}−2 bits for ψ, to further reduce the channel occupancy. The quantized values—q_{φ}={0, . . . , 2^{b}^{_{φ}}} and q_{ψ}={0, . . . , 2^{b}^{_{ψ}}} are packed into the compressed beamforming frame (step 3) and such beamforming feedback information (BFI) is transmitted (step 4) to the AP 202 in clear text. Each BFI contains A number of angles for each of the K OFDM sub-channels for a total of (K·A) angles each. FIG. 3 shows an example of how beamforming is conducted in an example 3×2 MIMO system. As noted herein, steps 1 through 4 of FIG. 2 depict how beamforming is implemented in IEEE 802.11 networks. Steps 5 through 8 depict additional steps according to the invention to utilize the BFI as disclosed in detail below, which is generated by the beamformees as part of the beamforming procedure, to determine the signal propagation environment.

A sensing system according to the described embodiments captures the BFI reports (step 5) and uses the channel estimation data to perform Wi-Fi sensing. We remark that, since MU-MIMO requires fine-grained channel sounding, about every 10 milliseconds, to account for user mobility. It is fundamental to process the BFI in a fast manner at the AP. For this reason, and since cryptography would lead to excessive delays, the angles are currently sent unencrypted. Therefore, the BFI reports are exposed to and can be read by any device that can access the wireless channel. Specifically, the described embodiments rely on the BFI transmitted by all the beamformees in the environment and captured during a time window of W seconds to reliably estimate the activity being performed by a human moving within the propagation environment. This is done by using the BFI samples collected within the window as input for a learning-based algorithm.

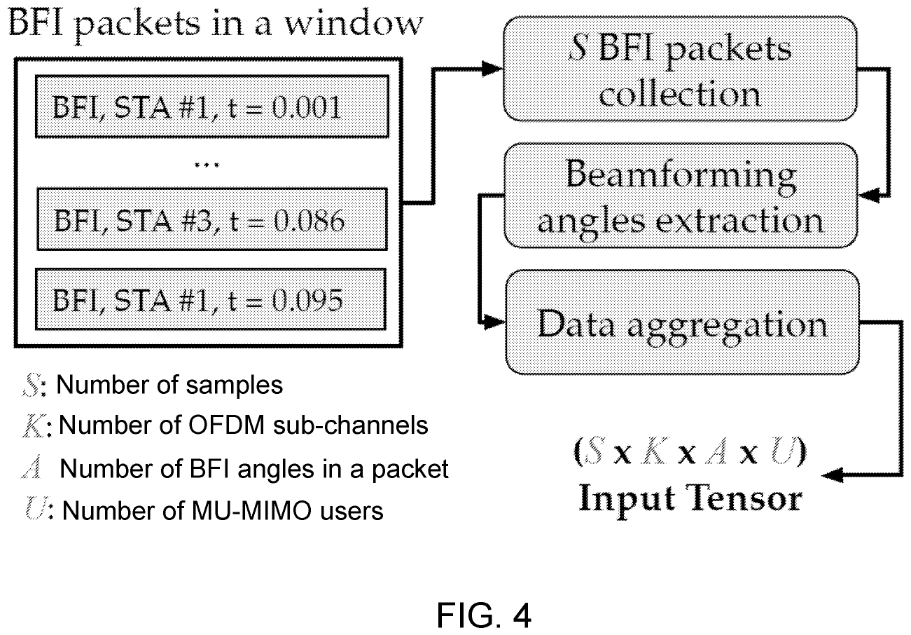

As the described embodiments leverage ongoing MU-MIMO transmissions, there is no guarantee that the same number of BFI frames are collected within a specific time interval of W seconds. This is related to the fact that a sensing system according to the invention has no control on when the beamformer triggers the channel sounding procedure that generates BFI data. Therefore, as the neural network-based classification algorithm requires the input to be of a fixed dimension, a fixed-size input that represents the BFI reports captured during the time window needs to be determined. The processing is applied just after having collected the data on the wireless channel (Reference number 210 in FIG. 2) and is summarized in FIG. 4. Specifically, we consider the average number S of BFI packets counted (at training time) in each window during an activity recording. Windows having less than S packets are padded with BFI packets containing zero-valued angles, while packets exceeding such threshold are discarded. Hence, the K×A BFI angles contained in each packet are extracted and the final tensor is obtained by aggregating the S×K×A angles for all the U MU-MIMO users for which the BFI data have been captured in the observation window.

Even if it would be possible to define learning algorithms that accept input of different sizes, this would lead to an increase in the complexity of the approach, both from the training and inference perspective. Therefore, to keep the model simple for implementation on devices that have memory and battery constraints, the described embodiments follow a fixed-input approach. To obtain the training data, the S×K×A×U tensors derived from the BFI packets captured during the data collection phase are stored in a dataset 212, together with their associated activity and/or phenomenon, and a timestamp (referring to step 6 in FIG. 2). This phase can be performed offline by sensing application vendors without requiring the users' cooperation. The trained model 214 (see step 7 in FIG. 2) may then be used for online sensing (see step 8 in FIG. 2).

In the example embodiments, MU-MIMO sounding procedure is performed at least every 10 ms, which corresponds to 100 BFI measurements/second. Since the frequency of channel sounding is not specified in the standard, and since the sounding measurement lasts approximately 500 microseconds, the BFI rate can theoretically reach 2000 BFI per second.

As an example, assume the activity recording is 300 seconds long, and Wis 0.1 seconds. Then, 3000 windows are present in the recording. Assume that the average number of packets in the considered windows is S=10. The windows presenting less than 10 packets are zero-padded. Considering a bandwidth of 80 MHz, according to the IEEE 802.11 standard, four angles describe each of the K=234 sub-channels where sounding is performed, i.e., the total number of OFDM subchannels (256) minus pilots and control sub-channels that are excluded from the sounding procedure. Assuming that U=3 users are connected to the AP, the resulting input tensor has dimensions 10×234×4×3, and presents a total size of 10×234×4×3=28080.

Existing research in CSI-based sensing has exposed that designing classifiers that are robust to changing the subject performing the activity (i.e., different people) and the environment where the activity is performed (i.e., different rooms) is very challenging. On the other hand, it is hardly feasible to collect a large amount of data for all possible scenarios. To address this key issue, a deep learning (DL)-based algorithm may be used for BFI-based activity classification. Such a DL-based algorithm is referred to herein as the Fast and Adaptive Micro Reptile Sensing (FAMReS), which is a few-shot learning (FSL) algorithm based on Reptile, which needs a limited set of new input data to generalize to unseen environments. FSL is a DL technique that leverages only small amounts of additional data to adapt to classes that are unseen at training time. Specifically, in K-way-N-shot FSL, the model is trained on a set of mini-batches of data that only have K different classes (ways) and N samples (shots) of each class. The key idea is that by feeding less data, the model is spurred to rapidly adapt to new tasks. This unique property makes FSL a strong candidate to tackle the diversity of environments. FSL can be categorized into embedding learning and meta-learning, among others. Specifically, Reptile is a gradient-based meta-learning algorithm that learns the model parameter initialization for rapid fine-tuning. The key idea is that there are some common features between different tasks that can be learned through meta-learning. Therefore, the model can be fine-tuned on a new task faster with the meta-learned weights instead of training it from the beginning. To find the initialization weights θ*, Reptile minimizes the expectation of the loss function L_{τ} with respect to the different tasks t, i.e.,

$${θ}^{*} = {min}_{θ} {𝔼}_{τ} \{ {L}_{τ} [ f ( 𝓍 , 𝓎 \vert θ ) ] \} , \qquad ( 6 )$$

where f(x, y|θ) is the model functional approximation between input data x and output y obtained with parameters θ. This is equivalent to finding the θ* that satisfies [symbol] _{τ}{∇_{θ}(L,(f(x,y|θ)])}=0 via, e.g., stochastic gradient descent (SGD). SGD finds θ* through an iterative procedure, by subsequently updating the value of θ with a new value θ′ based on the gradient information:

$${θ}^{′} = θ - β \frac{1}{n} {\sum }_{τ = 1}^{n} ( \frac{1}{m} {\sum }_{i = 1}^{m} {∇}_{θ} ( {L}_{τ} [ f ( {𝓍}_{i} , {𝓎}_{i} \vert θ ) ] ) ) \qquad ( 7 )$$

$$= θ - β \frac{1}{n} {\sum }_{τ = 1}^{n} ( θ - \tilde{θ} ) , \qquad ( 8 )$$

where n and m denote the number of tasks and sampled data points of each task, respectively, β is a scalar denoting the step size, and

$$\tilde{θ} = θ - α \frac{1}{m} {\sum }_{i = 1}^{m} {∇}_{θ} ( {L}_{τ} [ f ( {𝓍}_{i} , {𝓎}_{i} \vert θ ) ] )$$

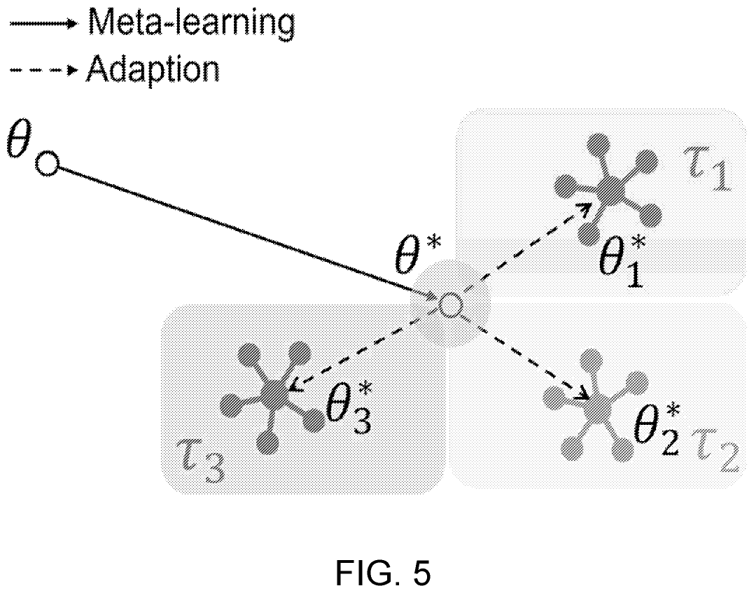

are the updated weights using m sampled data from t, where a denotes the learning rate. \tilde{θ} can be easily obtained using any deep learning API such as TensorFlow and PyTorch. The meta-learning proceeds through the following steps: (i) sample n new tasks {τ} with m data of each task (for K-way-N-shot, m is the product of K and N); (ii) compute \tilde{θ}; (iii) update θ with Equation (8); (iv) iterate (ii) and (iii) until the loss function stops decreasing. FIG. 5 shows how FSL is implemented through the Reptile algorithm: once obtained the initialization weights θ* through meta-learning, the model is fine-tuned on each different task.

The original purpose of Reptile is to extract meta-features from a large dataset so that it can be quickly fine-tuned when a new task is sampled from the given dataset. However, Reptile requires the inference and metalearning data to be sampled from the same dataset. Such a dataset should contain as many classes as possible so that the meta-learner can extract the general characteristics and fine-tune a task with fewer classes. Since this is unfeasible in BFI-based sensing, we find some common ground between meta-learning and general DL. The aim of learning is trying to approach the ground truth between different sampled data, while meta-learning is to find shared features between various tasks. Thus, if one considers each batch of training data as a new task in meta-learning, the learning problem can be converted into a meta-learning problem. Formally, we aim to find a set of parameters θ* that minimize the loss function/on training data xᵢ and yᵢ:

$${θ}^{*} = {min}_{θ} {𝔼}_{i} \{ L [ f ( {𝓍}_{i} , {𝓎}_{i} \vert θ ) ] \} . \qquad ( 9 )$$

By plugging the derivative [symbol] {∇_{θ}(L[f(xᵢ,yᵢ|θ)]} to the SGD optimizer, the optimization problem can be solved as

$$\tilde{θ} = θ - α \frac{1}{m} {\sum }_{i = 1}^{m} {∇}_{θ} ( L [ f ( {𝓍}_{i} , {𝓎}_{i} \vert θ ) ] ) . \qquad ( 10 )$$

By comparing Equation 7 with Equation 10, we find that if we set n=1 in Equation 7, the only difference between these two equations is a constant scalar. Based on this observation, we note that Reptile learns common ground from different mini-batch of data. The meta-learning rate, which is usually a scalar less than 1, is to adjust the step size of the learning, making it less likely to overfit the mini-batch data. This metalearning process can be regarded as a warm-up phase before learning, which makes the parameters θ closer to the ground truth in the hyperspace than random initial weights. Inspired by this idea, the procedure FAMReS according to the invention is divided into two stages: (i) meta-learning stage; and (ii) micro-learning stage. In stage (i), the model utilizes a small portion of data to learn the shared features. In stage (ii), the same micro dataset is used for training. The complete FAMReS workflow is reported in Algorithm 2.

Algorithm 2: The FAMReS Algorithm

```
Require: step size β, micro dataset [symbol]   ;
Initialize: a set of parameters θ;
for iteration = 1, 2, ... do
  sample k points of data from [symbol]   ; /*stage i*/
  compute \tilde{θ} using the SGD formulation;
  update the parameters: θ ← θ + β (\tilde{θ} − θ);
for epoch = 1, 2, ... do
  update θ running SGD on [symbol]   ; /*stage ii*/
```

FAMReS only uses a small portion of data in meta-learning and micro-learning and use other unseen data for testing. By contrast, Reptile uses the same dataset for both learning and inference. FAMReS is a strong candidate for online learning. FAMReS can run the metalearning phase while collecting new data. Once there is enough data, it can move on to the next stage. Therefore, a time variable & may be defined in experiments to simulate the real-time implementation. The data collected within the time window & may be used for learning and the other for inference. FAMReS is an empirical risk minimizer that can be unstable when using small values for 8, depending on the distribution of training data. Meta-learning on the micro dataset can only bring the initial parameters closer to the ground truth point in the hyperspace, but the final parameters still depend on the training set. Thanks to the high stability of the BFI data, we can always get a reasonable accuracy in the experiments unless Sis extremely small.

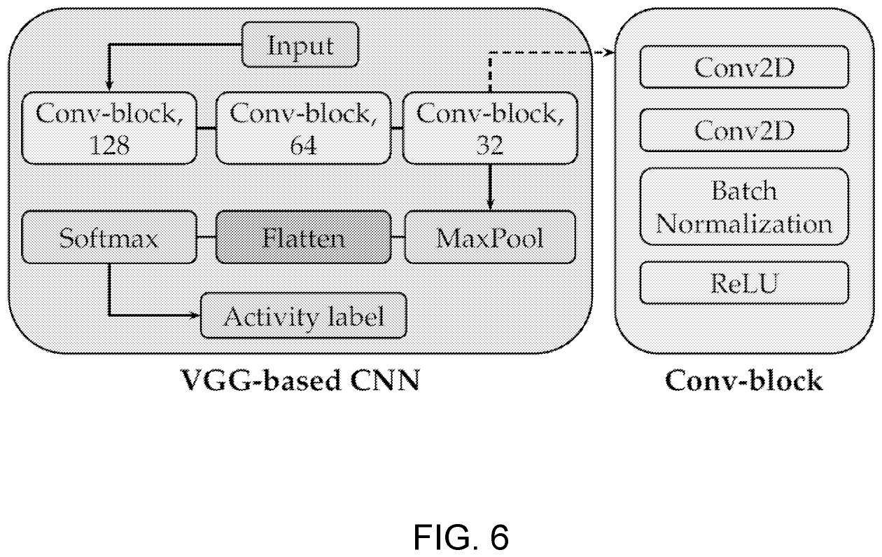

In the last decade, convolutional neural networks (CNNs) have achieved tremendous success in computer vision. The convolution layer, the basis of CNNs, can efficiently extract features by performing convolution operations on the elements of the input data. The described embodiments may use a visual geometry group (VGG)-based CNN architecture as the human activity classifier. An example network is depicted in FIG. 6 and entails stacking three convolutional blocks (conv-block) and a max-pooling (MaxPool) layer. Softmax is applied to the flattened output to obtain the probability distribution over the activity labels. The conv-block is a stack of two convolution two-dimensional (2D) layers. Following the design of VGG, each convolution layer has a kernel size of 3×3 and a step size of 1. To introduce non-linearity in the model, a rectified linear units (ReLU) activation function is applied at the end of each conv-block. Batch normalization is also used in conv-blocks to avoid gradient explosion or vanishing. The VGG-based CNN consists of three conv-blocks with 128, 64 and 32 filters, respectively. A descending order of filters is used to reduce the model size since features in lower layers are usually sparser and thus require extracting more activation maps to be properly captured.

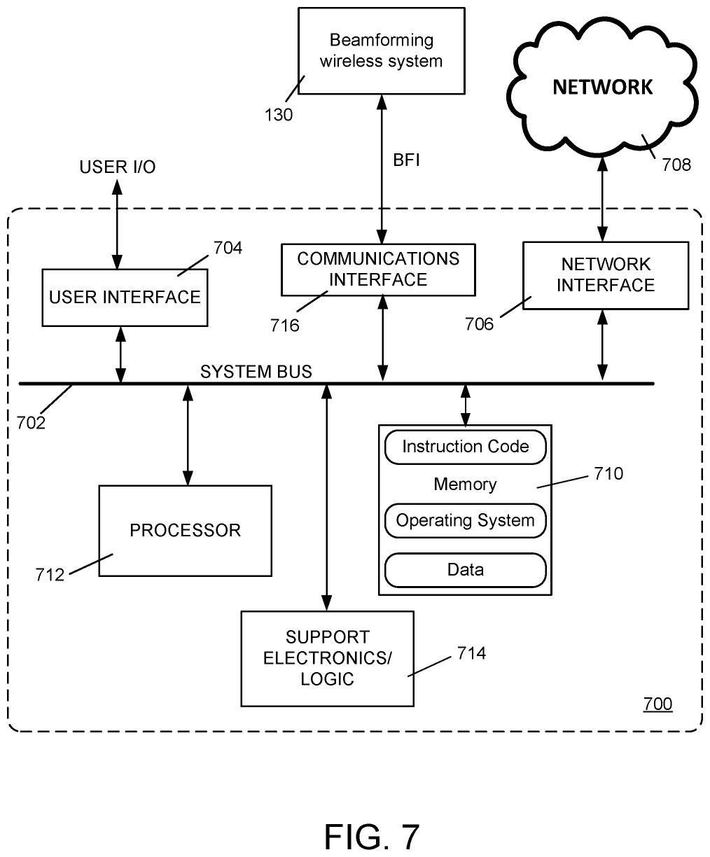

FIG. 7 is a diagram of an example internal structure of a processing system 700 that may be used to implement one or more of the embodiments herein. Each processing system 700 contains a system bus 702, where a bus is a set of hardware lines used for data transfer among the components of a computer or processing system. The system bus 702 is essentially a shared conduit that connects different components of a processing system (e.g., processor, disk storage, memory, input/output ports, network ports, etc.) that enables the transfer of information between the components.

Attached to the system bus 702 is a user I/O device interface 704 for connecting various input and output devices (e.g., keyboard, mouse, displays, printers, speakers, etc.) to the processing system 700. A network interface 706 allows the computer to connect to various other devices attached to a network 708. Memory 710 provides volatile and non-volatile storage for information such as computer software instructions used to implement one or more of the embodiments of the present invention described herein, for data generated internally and for data received from sources external to the processing system 700.

A central processor unit 712 is also attached to the system bus 702 and provides for the execution of computer instructions stored in memory 710. The system may also include support electronics/logic 714, and a communications interface 716. The communications interface may comprise an interface to a beamforming wireless system, as described with reference to FIG. 2, to receive, for example, the BFI.

In one embodiment, the information stored in memory 710 may comprise a computer program product, such that the memory 710 may comprise a non-transitory computer-readable medium (e.g., a removable storage medium such as one or more DVD-ROM's, CD-ROM's, diskettes, tapes, etc.) that provides at least a portion of the software instructions for the invention system. The computer program product can be installed by any suitable software installation procedure, as is well known in the art. In another embodiment, at least a portion of the software instructions may also be downloaded over a cable communication and/or wireless connection.

While example embodiments have been particularly shown and described, it will be understood by those skilled in the art that various changes in form and details may be made therein without departing from the scope of the embodiments encompassed by the appended claims.

What is claimed is:

1. A method of mapping a signal propagation environment, comprising:
receiving beamforming feedback information (BFI) produced by a wireless beamforming system;
extracting one or more beamforming parameters from the BFI, aggregating the one or more beamforming parameters, and storing the aggregated beamforming parameters in a labeled dataset; and
evaluating the aggregated beamforming parameters in the labeled dataset to generate a map of the signal propagation environment.

2. The method of claim 1, wherein the one or more beamforming parameters comprise one or more angles associated with a feedback matrix.

3. The method of claim 1, further comprising training, using the labeled dataset as one or more training vectors, a model of the signal propagation environment.

4. The method of claim 3, further comprising extracting the one or more beamforming parameters from one or more BFI packets.

5. The method of claim 4, wherein the one or more beamforming parameters from each BFI packet are stored with one or more of (i) an associated activity, (ii) an associated phenomenon, and (iii) a timestamp that designates when the BFI packet was collected.

6. The method of claim 1, further comprising training a model to perform classification of an activity, wherein the model implements a deep learning procedure.

7. The method of claim 6, wherein the deep learning procedure comprises a meta-learning stage and a micro-learning stage.

8. The method of claim 1, wherein the aggregated beamforming parameters comprise an input tensor of S×K×A×U, where S represents a number of BFI packets collected, K represents a number of OFDM sub-channels, A represents a number of BFI angles in each packet, and (represents a number of MU-MIMO users.

9. The method of claim 1, wherein the wireless beamforming system is an IEEE 802.11-based system.

10. A system for mapping a signal propagation environment, comprising:
a receiver configured to receive beamforming feedback information (BFI) produced by a wireless beamforming system;
a processor; and
a memory with computer code instructions stored thereon, the memory operatively coupled to the processor such that, when executed by the processor, the computer code instructions cause the system to:
extract one or more beamforming parameters from the BFI, aggregate the one or more beamforming parameters, and store the aggregated beamforming parameters in a labeled dataset; and
evaluate the aggregated beamforming parameters in the labeled dataset to generate a map of the signal propagation environment.

11. The system of claim 1, wherein the one or more beamforming parameters comprise one or more angles associated with a feedback matrix.

12. The system of claim 1, wherein the computer code instructions further cause the system to train, using the labeled dataset as one or more training vectors, a model of the signal propagation environment.

13. The system of claim 3, wherein the computer code instructions further cause the system to extract the beamforming parameters from one or more BFI packets.

14. The system of claim 4, wherein the one or more beamforming parameters from each BFI packet are stored with one or more of (i) an associated activity, (ii) an associated phenomenon, and (iii) a timestamp that designates when the BFI packet was collected.

15. The system of claim 1, wherein the computer code instructions further cause the system to train a model to perform classification of an activity, and the model implements a deep learning procedure.

16. The system of claim 6, wherein the deep learning procedure comprises a meta-learning stage and a micro-learning stage.

17. The system of claim 1, wherein the aggregated beamforming parameters comprise an input tensor of S×K×A×U, where S represents a number of BFI packets collected, K represents a number of OFDM sub-channels, A represents a number of BFI angles in each packet, and U represents a number of MU-MIMO users.

18. The system of claim 1, wherein the wireless beamforming system is an IEEE 802.11-based system.

19. A method of mapping a signal propagation environment, comprising:
receiving beamforming feedback information (BFI) produced by a wireless beamforming system;
extracting one or more beamforming parameters from the BFI, aggregating the one or more beamforming parameters, and storing the aggregated beamforming parameters in a labeled dataset;
constructing a set of training vectors using the labeled dataset;
training a model of the signal propagation environment by applying the set of training vectors to the model of the signal propagation environment.

20. The method of claim 19, further comprising training a classification model configured to classify an activity, wherein the model implements a deep learning procedure.
